(19) United States
(12) Patent Application Publication
(10) Pub. No.: US 2018/0165037 A1
(43) Pub. Date: Jun. 14, 2018

(54) Storage Reclamation in a Thin Provisioned Storage Device

(71) Applicant: HEWLETT PACKARD ENTERPRISE DEVELOPMENT LP, Houston, TX (US)

(72) Inventors: Shyamalendu Sarkar, Bangalore (IN); Anil Kumar Boogarapu, Bangalore (IN); Narayanan A N, Bangalore (IN); Venkata Subba Reddy N, Bangalore (IN)

(21) Appl. No.: 15/568,111

(22) PCT Filed: Jun. 23, 2015
(86) PCT No.: PCT/US2015/037228

§ 371 Date: Oct. 20, 2017

(30) Foreign Application Priority Data
Apr. 23, 2015 (IN) 2094/CHE/2015

(51) Int. Cl. G06F 3/06

(52) U.S. Cl. CPC G06F 3/0652; G06F 3/067; G06F 3/0643; G06F 3/0608

(57) ABSTRACT

Some examples described herein relate to reclamation of storage in a thin provisioned storage device. In an example, a determination may be made that storage space provisioned to a logical unit number (LUN) by a thin provisioned storage device is freed by a file system managing file system operations in the LUN. Storage space freed by the file system may be marked. Amount of marked storage space that may be released to the thin provisioned storage device may be determined, based on i) difference between rate of allocation and rate of release of storage blocks by the file system in the LUN, and ii) usage level of storage blocks in the thin provisioned storage device. The determined amount of marked storage space may be released to the thin provisioned storage device.

### BACKGROUND

Storage systems have become an integral part of modern day computing. Whether it is a small start-up or a large enterprise, organizations these days may need to deal with a vast amount of data that could range from a few terabytes to multiple petabytes. Storage systems or devices provide a useful way of storing and organizing such large amounts of data. However, going ahead, enterprises are looking at more efficient ways of utilizing their storage resources.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for reclaiming storage in a thin provisioned storage device;

FIG. 2 is a block diagram of an example system for reclaiming storage in a thin provisioned storage device;

FIG. 3 is a block diagram of an example system for reclaiming storage in a thin provisioned storage device;

FIG. 4 is a flowchart of an example method of reclaiming storage in a thin provisioned storage device; and

FIG. 5 is a block diagram of an example system for reclaiming storage in a thin provisioned storage device.

### DETAILED DESCRIPTION

Data management is vital to success of an organization. Whether it is a private company, a government undertaking, an educational institution, or a new start-up, managing data (for example, customer data, vendor data, patient data, etc.) in an appropriate manner is crucial for existence and growth of an enterprise. Storage systems play a useful role in this regard. A storage system allows an enterprise to store and organize data, which may be analyzed to derive useful information for a user. Thus, considering their usefulness, storage systems tend to garner a significant piece of share from the IT budget of an organization.

However, enterprises are now looking for meaningful ways to extract more value from their investments in storage resources. For instance, with an increasing need of just-in-time storage requirement for public and private cloud, multi-tenant NAS appliance, and file-based media for virtual machine (VM) clients, provisioning and effective utilization of available storage space has gained considerable importance for organizations. In this context, reclamation of storage space in a storage device or volume plays a significant role. Since reclamation of storage space in a storage device may involve I/O communication with the storage device, unless it is carried out at the right time and for the right quantum of blocks, it may impact I/O bandwidth and device performance. Also, an unnecessary reclamation i.e. reclamation without an actual requirement may incur a huge performance overhead. Hence, it is desirable that reclamation is performed at the right time and for the right quantum of blocks.

To address this issue, the present disclosure describes various examples for reclaiming storage in a thin provisioned storage device. In an example, upon determination that storage space provisioned to a logical unit number (LUN) by a thin provisioned storage device is freed by a file system managing file system operations in the LUN, the storage space freed by the file system may be marked. Further, a determination may be made to identify storage space that may be released from the marked storage space to the thin provisioned storage device. In an example, the determination may be made based on i) difference between rate of allocation and rate of release of storage blocks by the file system in the LUN, and ii) usage level of storage blocks in the thin provisioned storage device. The determined amount of the marked storage space may then be released to the thin provisioned storage device.

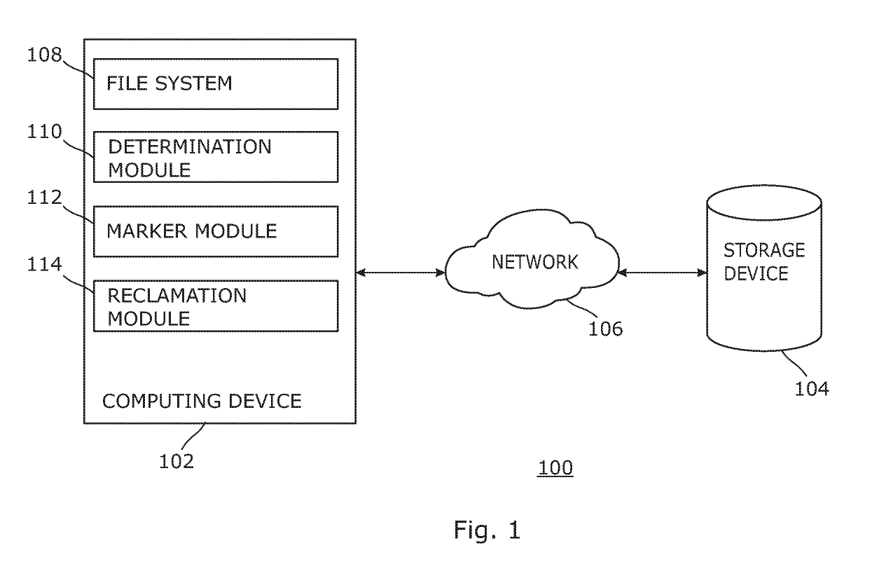

FIG. 1 is a block diagram of an example computing environment 100 for reclaiming storage in a thin provisioned storage device. In an example, computing environment 100 may include a computing device 102 and a storage device 104. Although only one computing device and one storage device are shown in FIG. 1, other examples of this disclosure may include more than one computing device and more than one storage device.

Computing device 102 may represent any type of computing system capable of reading machine-executable instructions. Examples of computing device 102 may include, without limitation, a server, a desktop computer, a notebook computer, a tablet computer, a thin client, a mobile device, a personal digital assistant (PDA), a phablet, and the like. In an example, computing device 102 may be a file server system or file storage system.

Computing device 102 may be in communication with storage device 104, for example, via a computer network 106. Such a computer network 106 may be a wireless or wired network. Computer network 106 may include, for example, a Local Area Network (LAN), a Wireless Local Area Network (WAN), a Metropolitan Area Network (MAN), a Storage Area Network (SAN), a Campus Area Network (CAN), or the like. Further, computer network 106 may be a public network (for example, the Internet) or a private network (for example, an intranet).

Storage device 104 may be any type of storage device. Storage device 104 may be an internal storage device, an external storage device, or a network attached storage device. Some non-limiting examples of storage device 104 may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, storage device 104 may be a Direct Attached Storage (DAS) device, a Network Attached Storage (NAS) device, a Redundant Array of Inexpensive Disks (RAID), a data archival storage system, or a block-based device over a storage area network (SAN). In another example, storage device 104 may be a storage array, which may include one or more storage drives (for example, hard disk drives, solid state drives, etc.).

Storage device 104 may communicate with computing device via a suitable interface or protocol such as, but not limited to, Fibre Channel, Fibre Connection (FICON), Internet Small Computer System Interface (iSCSI), HyperSCSI, and ATA over Ethernet.

In an example, physical storage space provided by storage device may be presented as a logical storage space to computing device 102. Such logical storage space (also referred as “logical volume”, “virtual disk”, or “storage volume”) may be identified using a “Logical Unit Number” (LUN). In another instance, physical storage space provided by storage device 104 may be presented as multiple logical volumes to computing device 102. In such case, each of the logical storage spaces may be referred to by a separate LUN. Thus, if storage device is physical disk, a LUN may refer to the entire physical disk, or a subset of the physical disk or disk volume. In another example, if storage device 104 is a storage array comprising multiple storage disk drives, physical storage space provided by the disk drives may be aggregated as a logical storage space. The aggregated logical storage space may be divided into multiple logical storage volumes, wherein each logical storage volume may be referred to by a separate LUN. LUNs, thus, may be used to identify individual or collections of physical disk devices for address by a protocol associated with a SCSI, iSCSI, or Fibre Channel (FC).

In an example, storage device 104 may be thinly provisioned. Thin provisioning (TP) is a method of optimizing the efficiency with which the available space is utilized in a storage device. Thin provisioning may be called as “just-in-time” provisioning. Thin provisioning allows allocation of disk storage space in a flexible manner among multiple clients (for example, LUNs). Thin provisioning enables provisioning of more storage on a LUN than what may be currently available on a volume. Thus, a thin provisioned storage system may include one or more flexible logical storage volumes supported by a fixed capacity storage device(s). In other words, a thin provisioned storage device may include a virtual storage capacity and a real storage capacity.

Storage device 104 may provide block level storage. In an example, logical storage space (or logical volume) may be divided into blocks. A “block” may be defined as a sequence of bytes or bits, having a nominal length (a block size). Data (for example, a file) may be organized into a block. A block may be of fixed length or variable length. A block may be defined at a logical storage level or at physical storage disk level. In an instance, file system on computing device 102 may use a block to store a file or directory in a logical storage space. In another example, a file or directory may be stored over multiple blocks that may be located at various places on a volume. In context of a physical storage space, a file or directory may be spread over different physical areas of a storage medium.

In the example of FIG. 1, computing device 102 may include a file system 108, a determination module 110, a marker module 112, and a reclamation module 114. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a computing device (e.g. 102).

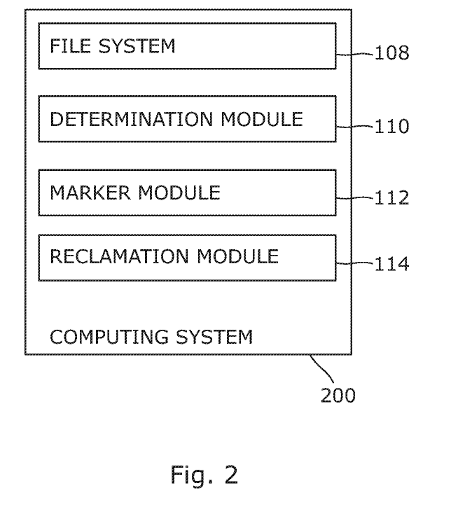

Some of the example functionalities that may be performed by file system 108, determination module 110, marker module 112, and reclamation module 114 are described in reference to FIG. 2 below.

FIG. 2 is a block diagram of an example computing system 200 for reclaiming storage in a thin provisioned storage device. In an example, computing system 200 may be analogous to computing device 102 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

Computing system 200 may be a server, a desktop computer, a notebook computer, a tablet computer, a mobile phone, a personal digital assistant (PDA), and the like.

In an example, computing system 200 may include a file system 108, a determination module 110, a marker module 112, and a reclamation module 114.

In an example, file system 108 may be associated with a storage volume(s) supported by a storage device (for example, 104). A storage volume may be referred to by a LUN. In general, file system 108 may manage file system operations in a LUN. Some non-limiting examples of file system operations may include creating, modifying, or deleting a file(s). Other operations may include reading and writing to files, renaming of files, and movement of files within directories in the file system 108. In an instance, file system 108 may use blocks on a storage volume to store file and directories. A file or directory may be stored over several blocks that may be located at various places on a volume. In an instance, file system 108 may include one or more file system objects. Some non-limiting examples of a file system object may include a file, a directory, an access control list (ACL), and the like. File system 108 may be a component of an operating system on computing system 200 or an independent component.

File system 108 may be a local file system or a scale-out file system such as a shared file system or a network file system. Examples of a shared file system may include a Network Attached Storage (NAS) file system or a cluster file system. Examples of a network file system may include a distributed file system or a distributed parallel file system. Some non-limiting examples of file system may include FAT (FAT12, FAT16, FAT32), NTFS, HFS and HFS+, HPFS, UFS, ext2, ext3, and ext4. File system may communicate with a storage device (for example, 104) via a suitable protocol. Some non-limiting examples of such protocol may include Network File System (NFS) protocol, Common Internet File System (CIFS) protocol, Hyper Text Transfer Protocol (HTTP), File Transfer Protocol (FTP), and the like.

Determination module 110 may determine whether storage space provisioned to a storage volume by a thin provisioned storage device is freed by a file system managing file system operations in the storage volume. In other words, if a file system frees a storage block(s) (for instance, upon deletion of a file) in a storage space allocated to a logical unit number (LUN) by a thin provisioned storage device, determination module 110 may identify the storage blocks freed by the file system. In an instance, the freed storage blocks may not result in a release of the actual data blocks to the underlying thin storage device supporting the LUN.

Marker module 112 may mark storage space freed by a file system. For instance, once determination module identifies storage blocks freed by a file system in a storage volume supported by a thin provisioned device, marker module 112 may assign a tag to the freed storage blocks for identification.

Reclamation module 114 may determine amount of the marked storage space that may be released to the thin provisioned storage device. In other words, reclamation module may determine whether entire, partial or none of the marked storage space may be released from the LUN to the underlying supporting thin provisioned storage device. In an example, reclamation module 114 may make the determination based on one or more parameters. In an instance, one of the parameters may be the difference between rate of allocation and rate of release of storage blocks by the file system that manages file system operations in the LUN. In other words, reclamation module 114 may consider the rate at which the file system is releasing and allocating storage blocks in the LUN that includes marked storage space. For example, for an interval between time t₁ and time t₂ (where t₂>t₁), the rate of release of storage blocks (for example, Rt₁t₂) in a LUN may be calculated as Rt₁t₂=R(t₂)−R(t₁), wherein Rt₁ and Rt₂ may represent number of released storage blocks at time t₁ and time t₂, respectively. Likewise, for the same time interval, the rate of allocation of storage blocks (for example, At₁t₂) in a LUN may be calculated as At₁t₂=A(t₂)−A(t₁), wherein At₁ and At₂ may represent number of allocated storage blocks at time t₁ and time t₂, respectively. The difference between allocated storage blocks and released storage blocks (for example, Ωt₁t₂) may be calculated as Ωt₁t₂=At₁t₂−Rt₁t₂. A lower Ωt₁t₂ may represent lower storage consumption in a LUN, whereas a higher Ωt₁t₂ may indicate higher storage consumption in the LUN. In an example, a threshold may be defined for (Ωt₁t₂), which may be a percentage of Ωt₁t₂ compared to total storage blocks in the LUN. To provide an example scenario, Ωt₁t₂ threshold may be defined as: i) low for file system usage of a LUN below 2%, ii) medium for file system usage of a LUN between 2% and 4%, and iii) high for file system usage above 4%. It may be mentioned that terms “low”, “medium”, and “high” are used herein in relative sense.

In an example, another parameter that reclamation module 114 may take into account to determine amount of the marked storage space that may be released to the thin provisioned storage device may include usage level of storage blocks in the thin provisioned storage device. In other words, reclamation module may consider number of used blocks in the thin provisioned storage device that supports the LUN comprising marked storage blocks. In an instance, various thresholds may be defined related to usage of storage space in a thin provisioned storage device. The thresholds may be user defined or system defined. To provide an example scenario, for a thin provisioned storage device with 100 GB of storage space, device usage thresholds may be defined as: i) very low for device usage below 10 GB, ii) low for usage between 10 GB-25 GB, iii) medium for usage between 25 GB-50 GB, iv) high for usage between 50 GB-80 GB, and v) very high for usage above 80 GB. It may be mentioned that terms “very low”, “medium”, “high” and “very high” are used herein in relative sense.

In an instance, reclamation module 114 may determine amount of marked storage space that may be released to a thin provisioned storage device based on a combination of factors. In an example, the combination of factors may include rate at which the file system is releasing and allocating storage blocks in the LUN that includes marked storage space, and usage level of storage blocks in the thin provisioned storage device. In an example, the amount of marked storage space that may be released to a thin provisioned storage device, as determined by reclamation module 114, may be modified by a user of the system. In other words, a user may or may not accept the determination made by reclamation module 114. In such case, the reclamation may occur only for the amount of storage space specified by a user. In other words, file system 108 may release only the amount of storage space specified by a user.

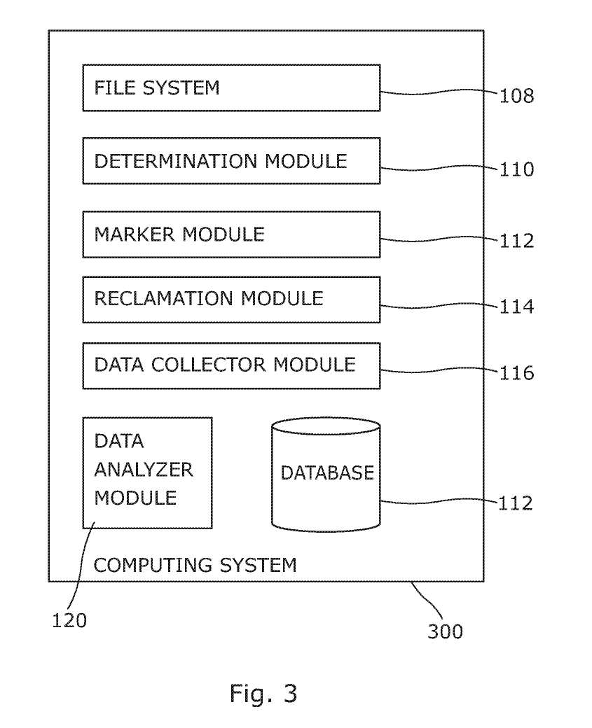

FIG. 3 is a block diagram of an example computing system 300 for reclaiming storage in a thin provisioned storage device. In an example, computing system 300 may be analogous to computing system of FIG. 2 (or computing device of FIG. 1), in which like reference numerals correspond to the same or similar, though perhaps not identical, components. For the sake of brevity, components or reference numerals of FIG. 3 having a same or similarly described function in FIG. 1 or 2 are not being described in connection with FIG. 3. Said components or reference numerals may be considered alike.

Computing system 300 may be a server, a desktop computer, a notebook computer, a tablet computer, a mobile phone, a personal digital assistant (PDA), and the like.

In an example, computing system 300 may include a file system 108, a determination module 110, a marker module 112, a reclamation module 114, a data collector module 116, a database 118, and a data analyzer module 120.

Data collector module 116 may collect a variety of data. Some non-limiting examples of data that may be collected by data collector module 116 may include data related to usage level of storage blocks in a thin provisioned storage device, number of storage blocks allocated by a file system in a storage volume, and number of storage blocks released by a file system in a storage volume. In an instance, data collected by data collector module 116 may be stored in database 118. Database 118 may also store other data such as device usage thresholds for a thin provisioned storage device, and storage configuration information.

Data analyzer module 120 may analyze data stored in database. For example, data analyzer module 120 may determine the difference between rate of allocation and rate of release of storage blocks by a file system in a storage volume that includes marked storage space.

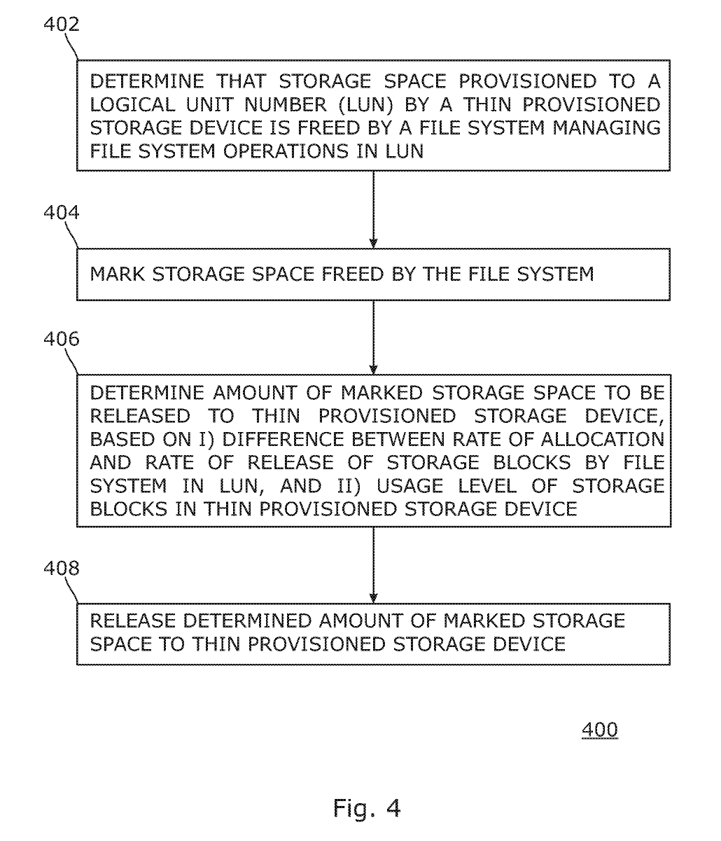

FIG. 4 is a flowchart of an example method 400 for reclaiming storage in a thin provisioned storage device. The method 400, which is described below, may at least partially be executed on a computing device 100 of FIG. 1 or computing systems 200 and 300 of FIGS. 2 and 3, respectively. However, other computing devices may be used as well. At block 402, a determination may be made that storage space provisioned to a logical unit number (LUN) by a thin provisioned storage device is freed by a file system managing file system operations in the LUN. At block 404, the storage space freed by the file system may be marked. At block 406, amount of the marked storage space that may be released to the thin provisioned storage device may be determined, based on i) difference between rate of allocation and rate of release of storage blocks by the file system in the LUN, and ii) usage level of storage blocks in the thin provisioned storage device. At block 408, the determined amount of the marked storage space may be released to the thin provisioned storage device. In an instance, the determined amount of the marked storage space may be released by the file system. In an example, the released storage space may be reallocated to same LUN. In another example, the released storage space may be allocated to a new or another LUN. In an instance, the new LUN may be provisioned by same thin provisioned storage device. In a further example, the marked storage space which is not released by the file system to the thin provisioned storage device may be preserved within the system. Such marked storage space may be combined with any previously marked storage space, and the determination at block 406 may be made from such aggregated marked storage space.

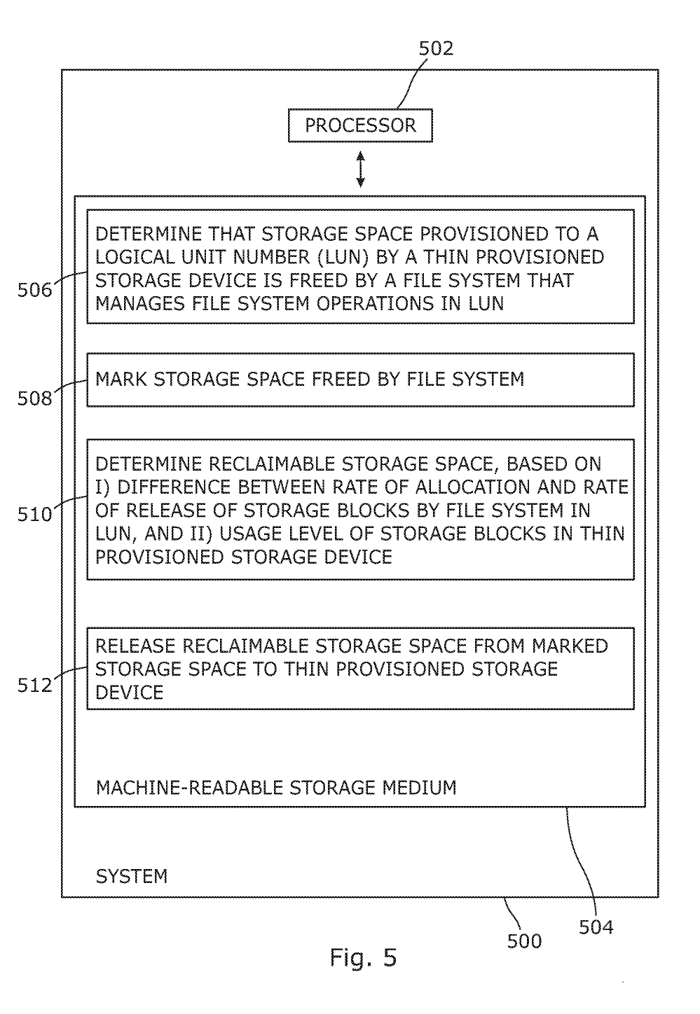

FIG. 5 is a block diagram of an example system 500 for reclaiming storage in a thin provisioned storage device. System 500 includes a processor 502 and a machine-readable storage medium 504 communicatively coupled through a system bus. In an example, system 500 may be analogous to system 100 of FIG. 1 or computing systems 200 and 300 of FIGS. 2 and 3, respectively. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 504 may be a non-transitory machine-readable medium. Machine-readable storage medium 504 may store instructions 506, 508, 510, and 512. In an example, instructions 506 may be executed by processor 502 to determine that storage space provisioned to a logical unit number (LUN) by a thin provisioned storage device is freed by a file system that manages file system operations in the LUN. Instructions 508 may be executed by processor 502 to mark the storage space freed by the file system. Instructions 510 may be executed by processor 502 to determine reclaimable storage space from the marked storage space, based on i) difference between rate of allocation and rate of release of storage blocks by the file system in the LUN, and ii) usage level of storage blocks in the thin provisioned storage device. Instructions 508 may be executed by processor 502 to release the reclaimable storage space from the marked storage space to the thin provisioned storage device.

For the purpose of simplicity of explanation, the example method of FIG. 4 is shown as executing serially, however it is to be understood and appreciated that the present and other examples are not limited by the illustrated order. The example systems of FIGS. 1, 2, 3, and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

We claim:

1. A method of reclaiming storage in a thin provisioned storage device, comprising:
determining that storage space provisioned to a logical unit number (LUN) by a thin provisioned storage device is freed by a file system managing file system operations in the LUN;
marking the storage space freed by the file system;
determining amount of the marked storage space to be released to the thin provisioned storage device, based on i) difference between rate of allocation and rate of release of storage blocks by the file system in the LUN, and ii) usage level of storage blocks in the thin provisioned storage device; and
releasing the determined amount of the marked storage space to the thin provisioned storage device.

2. The method of claim 1, wherein the determined amount of the marked storage space is released by the file system.

3. The method of claim 1, further comprising determining the rate of allocation and the rate of release of storage blocks by the file system in the LUN.

4. The method of claim 1, further comprising determining the usage level of storage blocks in the thin provisioned storage device.

5. The method of claim 1, wherein determining the amount of the marked storage space includes determining number of storage blocks for releasing from the marked storage space.

6. A system for reclaiming storage in a thin provisioned storage device, comprising:
a determination module to determine that storage space provisioned to a storage volume by a thin provisioned storage device is freed by a file system that manages file system operations in the storage volume;
a marker module to mark the storage space freed by the file system; and
a reclamation module to determine amount of the marked storage space to be released to the thin provisioned storage device, based on i) difference between rate of allocation and rate of release of storage blocks by the file system in the storage volume, and ii) usage level of storage blocks in the thin provisioned storage device, wherein further to the determination, the file system to release the determined amount of the marked storage space to the thin provisioned storage device.

7. The system of claim 6, further comprising the file system to release the determined amount of the marked storage space to the thin provisioned storage device.

8. The system of claim 6, further comprising a data collector module to collect data related to the usage level of storage blocks in the thin provisioned storage device, number of storage blocks allocated by the file system in the storage volume, and number of storage blocks released by the file system in the storage volume.

9. The system of claim 8, further comprising a database to store the data collected by the data collector.

10. The system of claim 8, further comprising a data analyzer module to determine the difference between rate of allocation and rate of release of storage blocks by the file system in the storage volume.

11. A non-transitory machine-readable storage medium comprising instructions for reclaiming storage in a thin provisioned storage device, the instructions executable by a processor to:
determine that storage space provisioned to a logical unit number (LUN) by a thin provisioned storage device is freed by a file system that manages file system operations in the LUN;
mark the storage space freed by the file system;
determine amount of reclaimable storage space from the marked storage space, based on i) difference between rate of allocation and rate of release of storage blocks by the file system in the LUN, and ii) usage level of storage blocks in the thin provisioned storage device; and
release the determined amount of reclaimable storage space from the marked storage space to the thin provisioned storage device.

12. The storage medium of claim 11, wherein the released storage space is reallocated to the LUN.

13. The storage medium of claim 12, wherein the released storage space is allocated to another LUN.

14. The storage medium of claim 13, further comprising instructions to:
modify the determined amount of reclaimable storage space in response to a user input; and
release the modified amount of reclaimable storage space to thin provisioned storage device in place of the determined amount of reclaimable storage space.

15. The storage medium of claim 11, wherein the thin provisioned storage device is one of a storage array, a network-attached storage (NAS) device, and a Storage Area Network (SAN) device.
